(19) United States
(12) Patent Application Publication
(10) Pub. No.: US 2007/0089155 A1
(43) Pub. Date: Apr. 19, 2007

(54) Electronic system to make televisions interactive

(75) Inventor: Mehmet Saydam, Istanbul (TR)

Correspondence Address: AKERMAN SENTERFITT, P.O. BOX 3188, WEST PALM BEACH, FL, 33402-3188, US

(73) Assignee: Tele Iletisim Teknolojileri San. Ve Tic. A.S., Istanbul (TR)

(21) Appl. No.: 10/570,061

(22) PCT Filed: Jun. 17, 2004
(86) PCT No.: PCT/TR04/00032

§ 371 Date: Dec. 8, 2006

(30) Foreign Application Priority Data
Sep. 1, 2003 (TR) 2003/01439

(51) Int. Cl. H04N 7/16; H04N 7/173

(52) U.S. Cl. 725/135; 725/102; 725/136

(57) ABSTRACT

The present invention relates to an electronic system to make the current televisions interactive, such system comprising at least one micro-processor based TV module (1) with bi-directional communication means connectable to a television, at least one central server computer saving the required user data and evaluating received data and making outcomes thereof, and at least one microprocessor based central module (2) with bi-directional communication means to ensure the communication between said central server computer and said TV module.

### TECHNICAL FIELD

The present invention relates to external electronic devices and systems providing extra features to televisions. The present invention particularly relates to electronic systems making televisions interactive and allowing such televisions to be controlled by a computer or a similar control device.

The prior art comprises certain devices used specifically in digital televisions to gain new functions in addition to existing ones to provide menus to allow users to control such functions. In installing such devices, a special cable connection and a special system is required in addition to the present cable systems of televisions. Such prior art devices with restricted functions provided to users cannot reach the desired functionality either.

Therefore, it shall be a desired improvement in the relevant art to provide an electronic system, which both is easily used and provides televisions of application with a number of functions already not covered in the prior art.

### BRIEF DESCRIPTION OF INVENTION

The present invention is related to a novel electronic system completely eliminating all aforesaid drawbacks and making a television interactive it is applied to.

The main objective of the present invention is to produce a functional electronic system, which, without requiring an extra cable and system, can be applied to analog and digital televisions of all types and gains such televisions with bi-directional communication capability, and as a result of these, adds more functions as compared to the devices of prior art, and allows all employed televisions to be controlled by a single central unit by means of wired or wireless communication, and finally, which has a low-cost and is practically applied and used.

The present invention provides a system to make current televisions interactive in order to achieve said main objective, such system comprising at least one micro-processor based TV module with bi-directional communication means connectable to a television, at least one central server computer, and at least one microprocessor based central module with bi-directional communication means to ensure the communication between said central server computer and said TV module and is characterized in that
said TV module delivers said central module the predetermined actions of the television it is connected to by utilizing its software, provides a menu allowing the relevant user to realize the system-related functions via the television, delivers the functions selected from this menu to the central module and applies the commands received from the central module to the television;
said central module ensures the communication between the TV module and the central server computer by performing necessary modulation/demodulation techniques by means of its software; and
said central server computer saves predetermined data of all users in connection with the system and responds to commands received from the TV module by further making an evaluation thereof, if necessary, according to said user data by utilizing its software; transmits said responds to the TV module via the central module; and allows handling the operation of TV modules connected to the system and/or receiving operation-related data from the TV modules.

In one preferred embodiment of the present invention, said TV module comprises transceiver circuit for bi-directional communication with the central module, a microprocessor unit to transfer all actions of TV to the central module and to apply the commands from the central module on the television, and a memory unit to save certain data received from the television.

In another preferred embodiment of the present invention, said TV module can be directly attached by connecting digital televisions' I2C bus terminals to said microprocessor's selected legs.

In a further preferred embodiment of the present invention, said TV module is connectable also to an analog television, by connecting the television's tuner terminals to the microprocessor unit through an ADC circuit within said TV module and by directly connecting the TV band terminal to the microprocessor unit.

Yet in a further preferred embodiment of the present invention, said central module comprises a transceiver circuit for bi-directional communication with the TV module, and a microprocessor unit to transmit the data received from the TV module to the central server computer by performing necessary communication protocol conversions for the use of the data by said server computer and to transmit the data received from the central server computer to the TV module by performing necessary communication protocol conversions for the use of the data by said TV module.

Still in a further preferred embodiment of the present invention, RF communication technique is employed between the TV module and central module and accordingly, the transceiver circuits in such modules are RF transceivers.

In another preferred embodiment of the present invention, the microprocessor units in said TV and central modules are micro-controllers.

In a further preferred embodiment of the present invention, said central module and central server computer communicates with the use of the RS232 serial communication technique and the central module comprises an RS232 communication interface to achieve this target.

In a preferred embodiment of the subject system, all data are sent in an encrypted form, and while sending data from the center to a TV module, the address data of a TV module of interest is further included in the data and all TV modules in the system evaluate the data upon receipt thereof and only the TV module conforming with the code and address data performs the desired operation.

In another preferred embodiment of the subject system, the central server computer controls the authority of a user to watch a channel, which he/she selects from the television by the TV module, and if he/she has the required authorization, such channel is activated and his/her user account is charged according to the period such channel is watched, or let active.

In a further preferred embodiment of the subject system, the preferred RF communication frequency is between 400-500 MHz, and this value is changed when desired, once the RF transceiver's operating frequency are changed by means of micro-controllers on the TV and central modules with digital signals by the central server computer.

Yet in a further preferred embodiment of the subject system, also the transmitting power of RF signals can be changed, once the RF transceiver's signal transmitting power are changed by means of micro-controllers on the TV and central modules with digital signals by the central server computer. Thanks to this feature, the system's operating range can easily be enhanced and reduced according to the field of application.

Still in a further preferred embodiment of the subject system, the user can participate in mutual messaging with a desired target point by using the menu for system functions appearing on the television. Such target point can be another television within the system, the central server computer, or if a modem is used in the central server computer, any other computer on the Internet.

In another preferred embodiment of the subject system, users can be informed and instructed with the of teletext modules of digital televisions.

In a further preferred embodiment of the subject system, a user is allowed to place orders via television, can learn his/her account remainder, receive wake-up services, change the menu language and/or the language for communication with the center, and play proper games by making a selection among those game machines in the center computer by making use of said system's function-related menu appearing on the television.

Yet in another preferred embodiment of the subject system, it is possible to change the channel frequencies and channel orders of the televisions one by one or group by group from the central server computer, to make language option adjustments, and to reach all televisions via the same lime under addressing logic. Still in another preferred embodiment of the subject system, advertisement and information broadcasts are activated before a user purchases a pay-program in payable broadcasts.

In a different preferred embodiment of the subject system, all adjustments and info acquisition (information of yields and statistics) towards the system can be realized by anyone by means such as the Internet from any location on the world, provided that such person holds the required authorization password.

The embodiment and advantages of the present invention shall be made clear with the figures described as following and the present invention is to be evaluated by taking into account such descriptions.

### BRIEF DESCRIPTION OF FIGURES

FIG. 1 is a block diagram of the TV module employed in the subject electronic device.

FIG. 2 is a block diagram of the central module employed in the subject electronic device.

### REFERENCE NUMBERS

1. TV module 1.5.1 TV Tuning terminal
1.1 Transceiver circuit 2. Central module
1.1.1 I/O connection 2.1 Transceiver circuit
1.2 Antenna 2.1.1 I/O connection
1.3 Memory unit 2.2 Antenna
1.4 Micro-control unit 2.3 Serial communication interface
1.4.1 TV I2C terminals 2.4 Micro-control unit
1.4.2 TV Band terminal 2.4.1 I/O connections
1.5 ADC
1.5.1 TV Tuning terminal
2. Central module
2.1 Transceiver circuit
2.1.1 I/O connection
2.2 Antenna
2.3 Serial communication interface
2.4 Micro-control unit
2.4.1 I/O connections

### DETAILED DESCRIPTION OF INVENTION

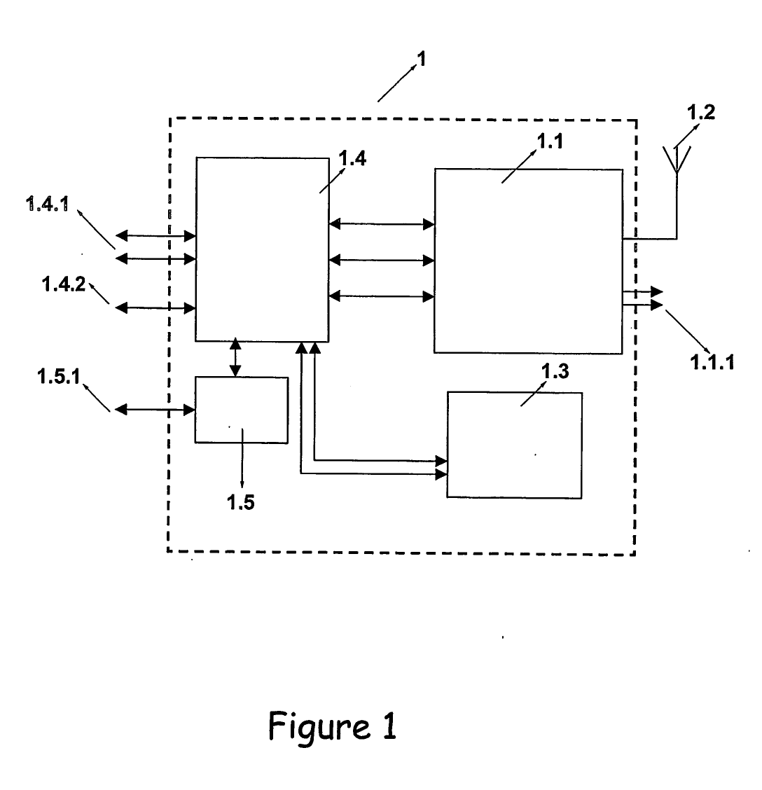

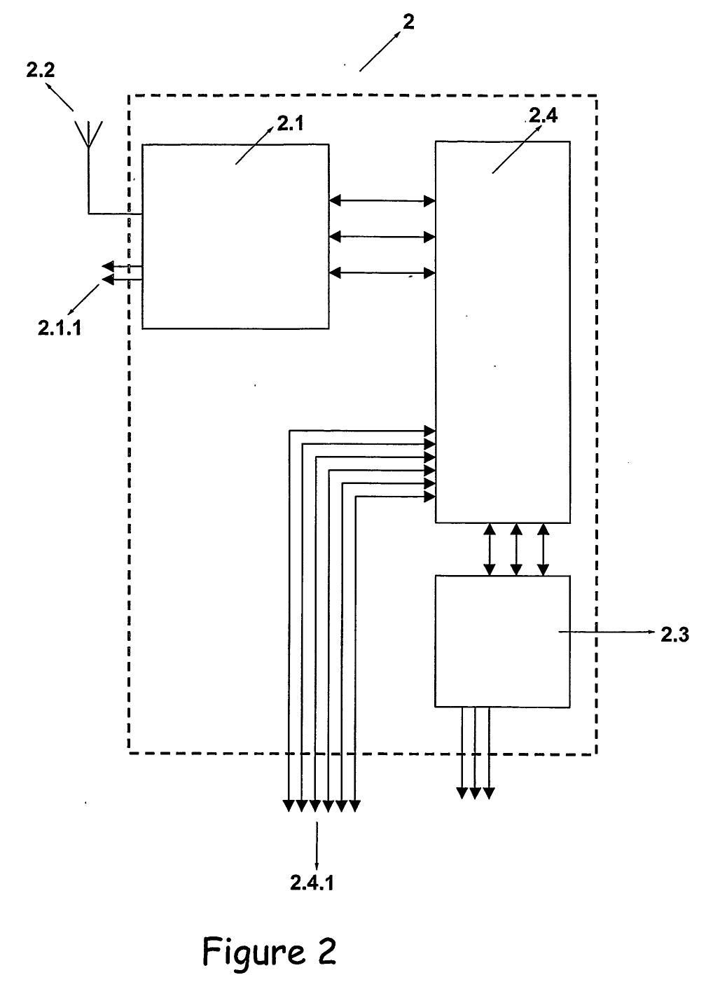

The subject system can be applied to both analog and digital based televisions and as previously mentioned, comprises a TV module (1) with the interior structure as given in FIG. 1 to be applied to such televisions, a central module (2) with the interior structure as given in FIG. 2 to be positioned in a computer or a similar central control unit, and a central computer to control the subject system by communicating with said center module.

Accordingly, digital signals from the television are sent to the RF transceiver (2.1) in the central module via an antenna cable or via air with the aid of the RF transceiver (1.1) of the TV module. And the former RF transceiver (2.1) converts such received signals into digital media and sends to the micro-control unit (1.4) in the central module, whereas the micro-control unit (1.4) converts such received signals to an RS232 protocol as understandable by the central server computer and sends to the central server computer by means of the RS232 communication interface (2.3). Notwithstanding in alternative embodiments of the present invention, the central module (2) can also employ wireless communication protocols (such as Bluetooth, Wi-Fi 802.11a, 802.11b, 802.11) with the central server computer. Likewise, it is possible to communicate with specific electronic control units by using a different serial communication protocol such as RS 485.

As a result, the central server computer evaluates such received data and sends the relevant record and responding messages back to the central module by means of the RS232 protocol and such arriving RS232 signals are received by the micro-control unit (1.4) and are broadcasted after being converted into radio frequencies again by the RF transceiver (2.1). Such broadcasted RF signals are received by the RF transceivers (1.1) of TV modules in listening mode on the other line and are transmitted to the micro-control units (1.4) by being converted into digital signals. As for the micro-control units (1.4), they evaluate such signals and thus, only the TV module having in its memory data conforming to the code and address data in the signal performs the required operations as provided in the signals.

The communication frequency in the entire system is the same and the separation at the center and terminals are made with the addressing method as mentioned hereinabove. The system's communication is realized with the logic “use the unoccupied line and then free it” and a multiple devices do not simultaneously use the communication line and frequency. The communication signals are encoded with special formulae in order to protect and keep apart the system from external factors. Thanks to this feature, no external signals can influence the system and signals with nonconforming formulae are not evaluated by any of system components.

In a preferred embodiment of the present invention, the radio frequencies are modulated as FSK (Frequency Shift Key). Again in this case operates the system preferably with radio signals of 400-500 MHz, and the RF transceiver operating frequency is programmable with digital signals. The centers operating frequency is 433 MHz and can be changed with +/−50 MHz steps and the output power can be adjusted between 10 mW and 100 mW. All these operations can be easily performed by means of a software program on the central server computer.

In another preferred embodiment of the present invention, the signal flow between the TV module (1) and central module (2) is performed up to 1000 m in a wirelessly medium and up to 3000 m via the internal antenna cable without support of external devices, and regarding longer distances, repeater units are employed for this purpose.

In the subject system, programs (software) are provided both in the TV and central module's micro-control units, and in the central server computer, to ensure the system's operation and the communication with users, and the functions of all such units as disclosed in this description are realized as a result of the interaction between these software and hardware units.

When the subject device is used in an analog television, it can provide only the function of pay-channel services. Accordingly, concerning the connection of an analog television, the TV band and TV tuning terminals (1.4.2, 1.5.1) of the TV module (1) are made to the television's tuner terminals. In this step, the TV band connection (1.4.2) is made to the terminal of the analog television's tuner to be employed in said pay-process (such as UHF, VHFL, VHFH, SB, etc.). Then the channels to be subjected for payment are adjusted to this band-frequency interval by the central satellite system. When a user passes to a program broadcasted in this band in any manner, the micro-control unit (1.4) in the TV module (1) senses this circumstance and transmits this status in an encoded and addressed from (address of the television in use) through the RF transceiver (1.1). As for the central module (2) sensing this broadcast, making reference to the relevant television user's authorization, it sends the responding message to the related television's TV module (1) by means of its micro-control unit (2.4) and RF transceiver (2.1) in an encoded and addressed form. All active TV modules receive this broadcast, but only the TV module (1) having the conforming address and code data sent in the broadcast evaluates such received signal. Accordingly, if the address data in the received signal is conforming and the codes are right, the relevant TV module makes an evaluation by means of the micro-control unit (1.4) and if the result of such assessment is “approvable,” the micro-control unit (1.4) produces a proper electrical signal, and by adjusting the band voltage, it opens the broadcast to the user. If it is not approvable, the broadcast is kept closed.

After the broadcast is started, the TV module (1) sends data to the central module (2) again through the RF transceiver (1.1), once the normal broadcast band is switched on. And the central module (2) receives this data and determines the duration the relevant channel is watched by means of the micro-control unit (1.4) and performs the pricing operation in line with this duration.

When the subject device is used on digital televisions, on the other hand, its used more efficiently and relatively more functions to a television it is applied to. The application manner, operating logic, and added functions are disclosed with all details as following.

During installation, the device is connected to the digital television through the TV I2C bus terminals (1.4.1) and thus the micro-control unit (1.4) becomes capable to communicate with the television through this connection and it becomes possible to make all actions and adjustments of the television (regardless of the mark and model of a relevant television) via this line. The micro-control unit (1.4) controls the television entirely through the RF transceiver (2.1) in the central module (2) according to received signals. The micro-control unit (1.4) senses also the television's channel adjustments, writings on the teletext display, the active (selected) channel, and signals from the controller, again by means of this I 2C bus. Thus the RF transceiver (1.1) in the TV module reports all actions to the center, and at the same time, reflects all actions from the center to the television.

As can be seen from FIGS. 1 and 2, there are also provided one apiece I/O terminals (1.1.1, 2.1.1) and thus one apiece antennas (1.2, 2.2) to receive such RF signals on the RF transceivers (1.1, 2.1) of the TV and central module for digital data communication.

Under the light of the foregoing disclosures, practical examples of the subject system are described below to clarify the present invention without imposing any restrictions thereon. Regarding the following description, it is assumed that the subject system is employed in a hotel.

When a visitor (or user) arrives at a hotel and checks in at the reception, the central server computer at the reception sends digital signals containing terminal address, personal information, TV status, and special messages (this message language can be configured in the ascii form) to the central module (2) by means of the RS232 line. Accordingly, the central module (2) receives such information and sends it to the line by means of its RF transceiver (2.1). Such transmitted signals are received by the RF transceivers (1.1) of the TV modules on the line in “waiting mode,” and the address and code data within such signal are checked by the micro-control units (1.4). If all conditions are fulfilled, the micro-control unit evaluates the arriving information and causes a message such as “Mr. Ahmet, Welcome to our Hotel!” to be displayed on the related television's display by means of the I2C bus line.

During usage, the user pushes a certain key on the television's remote control, enters into the internal teletext medium to use any of such functions, and selects the preferred operation or function from displayed menus or submenus. This medium is entirely controlled by the TV module's micro-control unit (1.4) accommodating a program that comprises in its memory all predetermined menu elements and that determines the relations between such menu elements and operations.

If the user, for example, wishes to query his/her accumulated account remainder in any computer program running in the central network system, she/he logs into the teletext medium by pushing a certain key on the television's remote control and select the relevant menu element. Then, he/she is requested to enter his/her room number and password to query his/her account. The user enters such requested information and this information is saved on the memory unit (1.3) of the TV module. Once this operation is completed and approved by the teletext medium, this information is send to the line by means of the RF transceiver (1.1) in an encoded form. The RF transceiver (2.1) in the central module receives this information and transmits it to the micro-control unit (2.4). And the central micro-control unit (2.4) evaluates this information and sends it to the central server computer through the RS232 port. The central server computer evaluates the received room number and password and receives the account information from the network; and if this account information is correct, it sends this information back to the central module (2) again through the RS232 port. The central module (2) evaluates this received information and if correct, it sends it back to the line through the RF transceiver (2.1). The TV module receives this information by means of its RF transceiver (1.1) and sends it to the micro-control unit (1.4). The micro-control unit (1.4) evaluates this information and switches the television to the teletext mode and displays the account information on the display, and then it switches back to the menu mode.

It is also possible to send e-mails by means of the television under the subject system, in a way similar to the foregoing operation principle. Accordingly, the user selects the relevant menu option similarly as disclosed above, composes the e-mail on the appearing display and sends it by pushing the relevant key on the television's remote control. The TV module (1) receiving the e-mail content and address-related text information sends such data to the central module (2) through the RF line, and the central module (2) causes these data to be sent to such desired e-mail address through the Internet by means of the server computer's or any other relevant computer's modem.

It becomes also possible to play games broadcasted from the center (such as Playstation, PC games, etc.) on the television under the present invention. Accordingly, the broadcast frequencies of game channels of predetermined games placed between broadcasts are installed on the central server computer. When the user switches to the games section by means of the menu options, this action is immediately sensed by the TV module (1), and the central server computer is reported accordingly.

The number of available games within the central server computer is reported back to the micro-controller unit (1.4) of the TV module from the central module via the RF technology. In this manner, available game lists are displayed on the TV so that the user makes a selection therefrom. Such selected game is sent to the central module (2) through the TV module, and then the central module (2) transmits the information required to switch the TV module (1) to such selected game's channel. Once the selected game channel is activated, a continuous data flow is provided to the center by the TV module (1) or by a specially designed control unit, and the joystick control of central game machines connected to the central module's I/O connection (2.4.1) is provided accordingly.

As can be seen from the foregoing disclosures, the present invention allows managers/owners of enterprises such as hotels to practically provide a number of services with small installation costs specifically in satellite and similar broadcasting systems of payless and payable TV programs etc. composed of a number of analog or digital televisions.

1. A system to make current televisions interactive, such system comprising at least one micro-processor based TV module with bi-directional communication means connectable to a television, at least one central server computer, and at least one microprocessor based central module with bi-directional communication means to provide the communication between said central server computer and said TV module, wherein
said TV module delivers said central module the predetermined actions of the television it is connected to by utilizing its software, provides a menu allowing the relevant user to realize the system-related functions via the television, delivers the functions selected from this menu to the central module and applies the commands received from the central module to the television;
said central module ensures the communication between the TV module and the central server computer by performing necessary modulation/demodulation techniques by means of its software; and said central server computer saves predetermined data of all users in connection with the system and responds to commands received from the TV module by further making an evaluation thereof, if necessary, according to said user data by utilizing its software; transmits such responds to the TV module via said central module; and allows handling the operation of TV modules connected to the system and/or receiving operation-related data from the modules.

2. A system according to claim 1, wherein said TV module comprises a transceiver circuit for bi-directional communication with the central module, a microprocessor unit to transfer all actions of TV to the central module and to apply the commands received from the central module to the television, and a memory unit to save certain data received from the television.

3. A system according to claim 1, wherein said TV module can be directly attached by connecting digital televisions' 12C bus terminals to said microprocessor's selected legs/terminals.

4. A system according to claim 1, wherein said TV module is connectable also to an analog television, by connecting the television's tuner terminals to the microprocessor unit through an ADC circuit within said TV module and by directly connecting the TV band terminal to the microprocessor unit.

5. A system according to claim 1, wherein said central module comprises a transceiver circuit for bi-directional communication with the TV module, and a microprocessor unit to transmit the data received from the TV module to the central server computer by performing necessary communication protocol conversions for the use of the data by said server computer and to transmit the data received from the central server computer to the TV module by performing necessary communication protocol conversions for the use of the data by said TV module.

6. A system according to claim 1, wherein RF communication technique is employed between the TV module and central module and accordingly, the transceiver circuits in the modules are RF transceivers.

7. A system according to claim 1, wherein the microprocessor units in said TV and central modules are micro-controllers.

8. A system according to claim 1, wherein said central module and central server computer communicates with the use of the RS232 serial communication technique and the central module comprises an RS232 communication interface to achieve this target.

9. A system according to claim 1, wherein all data are sent in an encrypted form, and while sending data from the center to a TV module, the address data of a TV module of interest is further included in the data and all TV modules in the system evaluate the data upon receipt thereof and only the TV module conforming with the code and address data performs the desired operation.

10. A system according to claim 1, wherein the central server computer controls the authority of a user to watch a channel, which he/she selects from the television by the TV module, and if he/she has the required authorization, such channel is activated and his/her user account is charged according to the period such channel is watched, or let active.

11. A system according to claim 1, wherein on digital televisions, the user can participate in mutual messaging with a desired target point by using the menu for system functions appearing on the television.

12. A system according to claim 11, wherein such target point can be another television within the system, the central server computer, or if a modem is used in the central server computer, any other computer on the Internet.

13. A system according to claim 1, wherein on digital television, users can be informed and instructed with the use of teletext modules of televisions according to the data the TV module receives from the center.

14. A system according to claim 1, wherein on digital televisions, the user is allowed to place orders via television, can learn his/her account remainder, receive wake-up services, change the menu language and/or the language for communication with the center, and play proper games by making a selection among those game machines in the center computer by making use of said system's function-related menu appearing on the television and by means of the bi-directional communication of the TV module with the center.

15. A system according to any of the preceding claim 1, wherein it is possible to change the channel frequencies and channel orders of the televisions one by one or group by group from the central server computer, to make language option adjustments, and to reach all televisions via the same lime under addressing logic.

16. A system according to claim 1, wherein advertisement and information broadcasts are activated before a user purchases a pay-program in payable broadcasts.

17. A system according to claim 1, wherein all adjustments and info acquisition towards the system can be realized by anyone by means of the Internet from any location on the world, provided that such person holds the required authorization password.

18. A system according to claim 1, wherein the preferred RF communication frequency is between 400-500 MHz, and this value is changed when desired, once the RF transceiver's operating frequency are changed by means of micro-controllers on the TV and central modules with digital signals by the central server computer.

19. A system according to any of the preceding claim 1, wherein the transmitting power of RF signals can be changed, once the RF transceivers', signal transmitting power are changed by means of micro-controllers on the TV and central modules with digital signals by the central server computer.
